(19) United States
(12) Patent Application Publication
(10) Pub. No.: US 2007/0103504 A1
(43) Pub. Date: May 10, 2007

(54) Maintenance Device for Cleaning Ink Cartridge Print Heads

(76) Inventor: Shr-How Huang, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/558,412

(22) Filed: Nov. 9, 2006

(30) Foreign Application Priority Data
Nov. 10, 2005 (TW) 094139401

(51) Int. Cl. B41J 2/165

(52) U.S. Cl. 347/29

(57) ABSTRACT

A maintenance device used for cleaning a print head of an ink cartridge includes a maintenance module including a base, a cap for capping the print head of the ink cartridge, and a cap sled installed on the base in a sliding manner for driving the cap upwards to cover the print head of the ink cartridge. A rack is installed on an end of the cap sled. The maintenance device further includes a pump module for pumping the ink out of the print head of the ink cartridge. The pump module includes a pump gear engaged with a feed gear, a swing gear engaged with the pump gear, and a swing gear when the feed gear drives the pump gear and the pump gear drives the swing arm.

### BACKGROUND OF THE INVENTION

1. Field of the Invention

The present invention relates to a maintenance device capable of cleaning a print head of an ink cartridge, and more particularly, to a maintenance device capable of capping a print head of an ink cartridge, removing ink residue from the print head, pumping ink from the print head of the ink cartridge, and scraping off the ink residue from a wiper without requiring an external driving force to achieve the above functions.

2. Description of the Prior Art

Modern office equipment utilized for document processing includes: printers, fax machines, photocopiers, and many other similar devices. To meet the high quality standards that are expected of printing devices, the most commonly used being the ink jet printer; most machines will require an external maintenance device. Most ink jet printers also require an external maintenance device for cleaning and maintaining the print head. The external maintenance device helps to prevent ink smudges and ensure that each printed sheet is error-free.

The primary components of the external maintenance devices currently on the markets are: a wiper, a cap, a scraper, and a pump. The primary function of the wiper is to remove the ink residue from the print head. The function of the cap is to cover the print head when the print head returns to an original point. The print head cover is to prevent the ink residue from drying, which can cause congestion in a nozzle. The function of the scraper is to scrape the ink residue off the wiper. Finally, the primary function of the pump is to pump ink to the dry print head before a printing job. This is necessary to ensure the quality of the output document will not affected by a dry nozzle.

In the case when the maintenance device in the modern office equipment supports all four functions as described above, the office equipment will require a third motor in addition to a first motor, used for feeding paper, and a second motor, used for moving a carriage that carries the ink cartridge back and forth. The third motor is necessary for supporting the operation of the four maintenance functions. For example, U.S. Pat. No. 5,997,128 discloses a technology that utilizes the third motor for driving the wiper and the cap, if the third motor is not utilized; the number of driving component is increased to drive the sled carrying the wiper and the cap back and forth within the printer. Additionally, in this architecture, if an increase in the pump function is required a resulting possibility is a separation of the pump tube due to the back and forth action of the cap. U.S. Pat. No. 6,520,620 discloses a technology that utilizes the third motor to achieve the functions of removing the ink residue, capping the print head, and pumping ink, but the technology still cannot remove the ink residue on the print head during the printing operation. U.S. Pat. No. 6,742,863 discloses that the force of the non-ink cartridge carrier is required to drive (i.e., force of the motor) the wiper architecture, but the technology still cannot remove the ink residue on the print head. U.S. Pat. No. 6,168,257 discloses a technology that utilizes the back and forth action of the ink cartridge carriage to drive the cap and the wiper, the wiper utilizes the method of moving diagonally upwards and in between the two corners of the carriage, but the function of the scraper cannot be integrated with this architecture, thus the ink residue on the wiper may cause an ink smudge problem. Additionally, with regard to the action of the carriage driving the cap, the capping force and the size of the motor must be appropriate otherwise, the capping function will fail, furthermore, the failed capping function will cause the pumping function to fail. Additionally, this design can cause an increase in the width of the maintenance device, which is undesirable given the current trend towards miniature design.

### SUMMARY OF THE INVENTION

The claimed invention provides a maintenance device capable of capping a print head of an ink cartridge, cleaning ink residue from the print head, pumping ink from the print head of the ink cartridge, and scraping the ink residue off a wiper without requiring an external driving force to perform the above-mentioned operations.

The claimed invention discloses a maintenance device capable of cleaning a print head of an ink cartridge, the maintenance device comprises a maintenance module comprising a base, a cap for capping a print head of an ink cartridge, a cap sled installed on the base in a sliding manner for driving the cap upwards to cover the print head of the ink cartridge, an end of the cap sled having a rack. The maintenance device further comprises a pump module for pumping ink out of the print head of the ink cartridge, the pump module comprises a pump gear for engaging a feed gear, a swing gear for engaging the pump gear, and a swing arm coupled to the pump gear and the swing gear for driving the swing gear when being driven by the pump gear when the feed gear is driving the pump gear; wherein the swing gear and the rack of the cap sled are installed at a location corresponding to where the swing gear engages the rack of the cap sled when the swing arm moves the swing gear to a predetermined position.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates an external view of a maintenance device according to the present invention.

FIG. 2 illustrates an external view of a maintenance device according to the present invention.

FIG. 3 illustrates an external view of a pump module.

FIG. 4 illustrates a diagram of a maintenance device in an initialization status.

FIG. 5 illustrates a diagram of a maintenance device in an operational status.

FIG. 6 illustrates a diagram of a swing gear driving a cap sled in a +X direction.

FIG. 7 illustrates a diagram of a bar resisting rotation of a swing bar.

FIG. 8 illustrates a diagram of a swing gear driving a cap sled in a −X direction.

FIG. 9 illustrates a diagram of a carriage carrying two ink cartridges at different locations when a wiper sled is in an operational status of raising the wiper.

FIG. 10 illustrates a diagram of a carriage carrying two ink cartridges at different locations when a wiper sled is in an operational status of raising the wiper.

### DETAILED DESCRIPTION

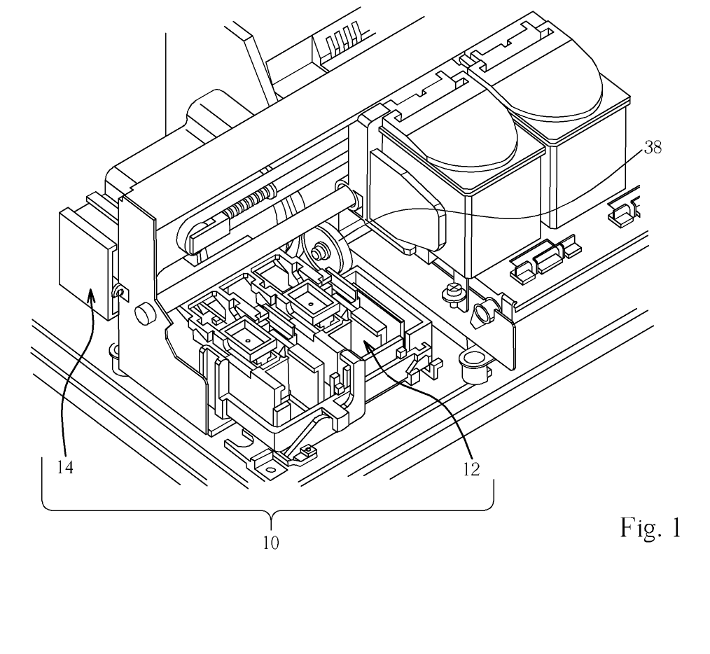

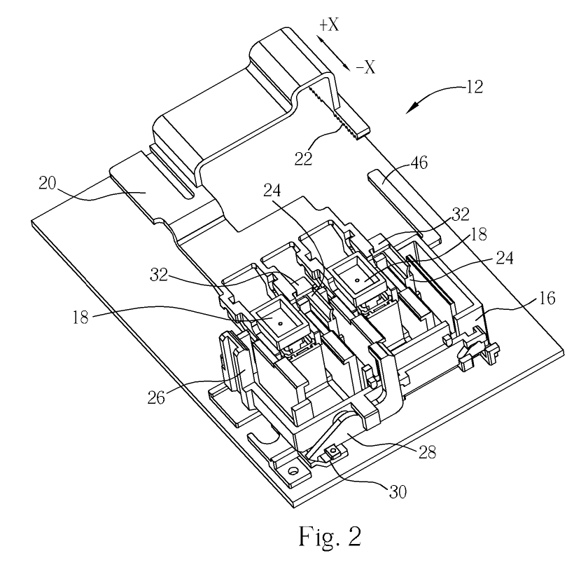

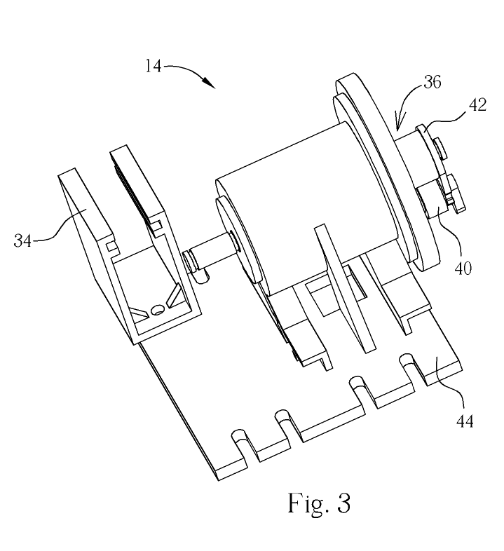

Please refer to FIG. 1. FIG. 1 illustrates an external view of a maintenance device 10 according to the present invention. The maintenance device 10 includes a maintenance device 12, and a pump device 14. Please refer to FIG. 2 and FIG. 3. FIG. 2 illustrates an external view of a maintenance device 12 according to the present invention. FIG. 3 illustrates an external view of a pump module 14. As shown in FIG. 2, the maintenance device 12 includes a base 16, two caps 18 for capping a print head of two ink cartridges, in this embodiment the maintenance device 12 is utilized for maintaining the print system of the twin ink cartridge, if the maintenance device 12 is utilized for maintaining a print system having a different number of ink cartridges, then a corresponding number of caps will be installed, a cap sled 20 installed on the base that moves in a sliding manner, the cap sled 20 is utilized for the maintenance of driving the cap upwards to cover the print head of the ink cartridge, an end of the cap sled 20 includes a rack 22, two wipers 24, a wiper sled 26 for pushing a carriage of the ink cartridge being carried upwards to drive the wiper 24, and a lock bar 28 connected to the wiper sled 26 for wedging a stop component 30 of the base 16 to secure the wiper sled 26, wherein the stop component 30 is a convex block, an end of the lock bar 28 is a hook structure for wedging the convex block. The maintenance device 12 further comprises two scrapers 32, installed on the cap sled 20, for scraping ink residue off each wiper 24 when the cap sled 20 and the wiper 24 generate a corresponding movement, and a cap sled support 34 for limiting the movement direction of the cap sled 20. As shown in FIG. 3, the pump module 14 is utilized for pumping ink out of the print head of the ink cartridge, the pump module 14 includes a pump gear 36 engaged with a feed gear 36 (as shown in FIG. 1) and a swing gear 40 engaged with the pump gear 36, and a swing arm 42 connected to the pump gear 36 and the swing gear 40 for moving the swing gear 40 being driven by the pump gear 36 when the feed gear 38 drives the pump gear 36 so that the swing gear 40 can engaged the rack 22 of the cap sled 20, thus the swing gear 40 and the rack 22 of the cap sled 20 are installed on corresponding positions where the swing gear 40 engages the rack 22 of the cap sled 20 when the swing arm 42 moves the swing gear 40 to a predetermined location. The driving force of the pump 14 comes from the feed gear 38, a feed roller rotates to drive the feed gear 38. As the feed gear 38 and the pump gear 36 engage each other, the feed gear 38 can drive the pump gear 36 to rotate and compress a tube of a support 44 to pump ink out of the ink cartridge capped by the cap 18. Furthermore, a bar 46 is installed on the wiper sled 26 for resisting the rotation of the swing gear.

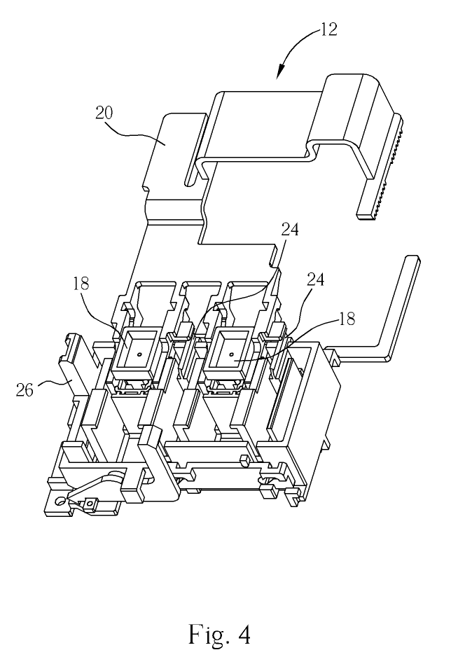

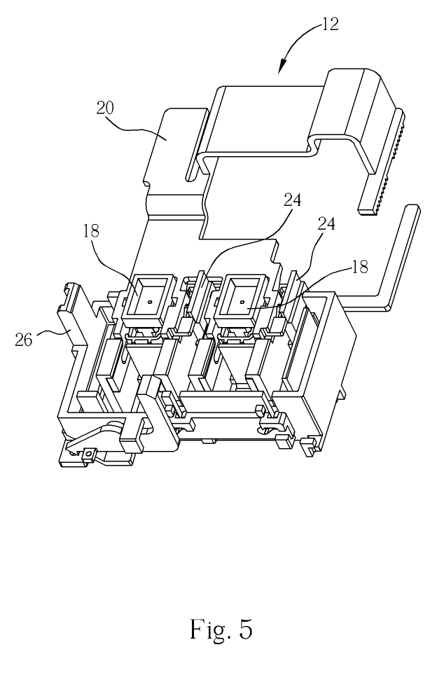

Please refer to FIG. 4 and FIG. 5. FIG. 4 illustrates a diagram of a maintenance device 12 in an initialization status. FIG. 5 illustrates a diagram of a maintenance device 12 in an operational status. When a printer is in a printing status, the maintenance device 12 is in the initialization status as shown in FIG. 4, the cap sled 20 and the wiper sled 26 are also in the initialization status, thus the cap 18 and the wiper 24 are not raised yet; when the printer is in a capping and pumping ink status, the cap sled 20 and the wiper sled 26 are in an operational status, which drives the cap 18 and the wiper 24 to rise.

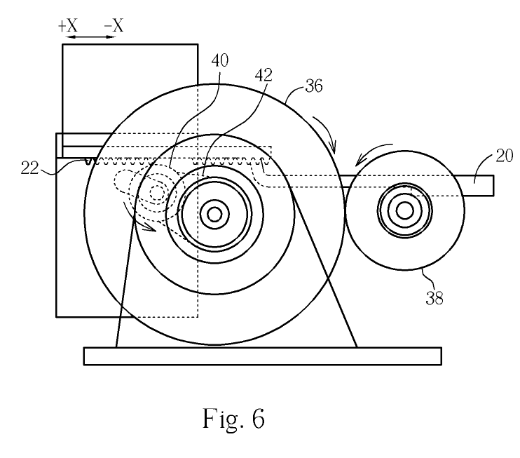

Please refer to FIG. 6 for an explanation of the operational theory of the cap sled 20 being driven. FIG. 6 illustrates a diagram of a swing gear 40 driving a cap sled 20 in a +X direction. When the wiper sled 26 is in the initialization status, if the printer is in a status of feeding paper, the feed gear 38 rotates in an counter-clockwise direction, and as the feed gear 38 engages the pump gear 36, the feed gear 38 drives the pump gear 36 to rotate in a clockwise direction, the swing arm 42 coupled to the pump gear 36 at the same time is also being driven by the pump gear 36 to rotate with the axis of the pump gear 36 in the clockwise direction, therefore the swing gear 40 that is connected to the swing arm 42 also rotates with the axis of the pump gear 36 in the clockwise direction, and when the swing arm 42 rotates in the clockwise direction to engage with the swing gear 40 and the rack 22 of the cap sled 20, as the swing gear 40 itself is already engaged with the pump gear 36, thus the pump gear is being driven to rotate in the counter-clockwise direction, at this time the cap sled 20 is being driven in the +X direction as shown in FIG. 2 and FIG. 5, and the cap 18 moves downwards along the slanting track of the cap sled 20 such that the cap 18 is not able to rise to the position needed for capping the print head of the ink cartridge.

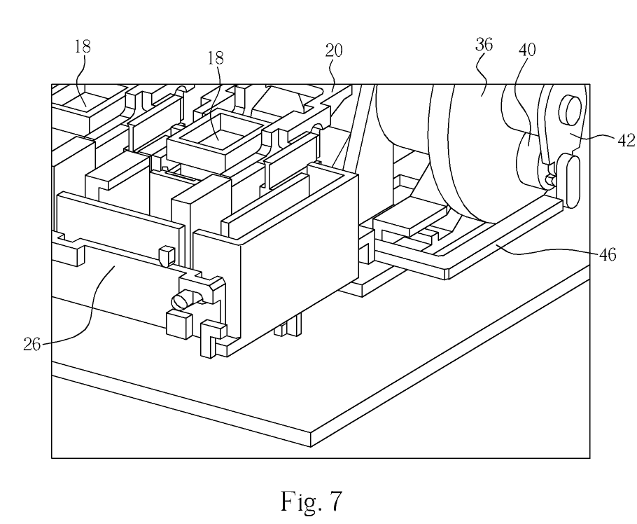

Please refer to FIG. 7. FIG. 7 illustrates a diagram of a bar 46 resisting rotation of a swing bar 40. As shown in FIG. 6 and FIG. 7, when the wiper sled 26 is in the initialization status, if the feed gear 38 is rotating in the clockwise direction to drive the pump gear to rotate in the counter-clockwise direction, at the same time the swing arm 42 that is connected to the pump gear 36 is being driven by the pump gear 36 to rotate with the axis of the pump gear in the counter-clockwise direction, therefore the swing gear 40 that is connected to the swing arm 42 also rotates in the counter-clockwise direction with the axis of the pump gear 36. At this time the wiper sled 26 is in the initialization status, thus the bar installed on the wiper sled 26 resists the rotation of the swing gear 40, and the cap sled 20 cannot be driven, hence the cap 18 cannot rise to the position needed for capping the print head of the ink cartridge.

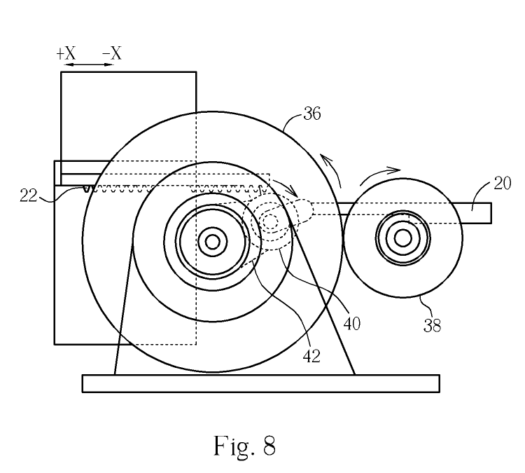

Please refer to FIG. 8. FIG. 8 illustrates a diagram of a swing gear 40 driving a cap sled 20 in a −X direction. When the carriage of the ink cartridge moves to the capping position to perform capping, the wiper sled 26 is in the operational status of raising the wiper 24, if the feed gear 38 rotates in the clockwise direction, and as the feed gear 38 engages the pump gear 36, the feed gear 38 drives the pump gear 36 to rotate in the counter-clockwise direction, the swing arm 42 that is connected to the pump gear 36 at the same time is also being driven by the pump gear 36 to rotate with the axis of the pump gear 36 in the counter-clockwise direction, therefore the swing gear 40 that is connected to the swing arm 42 also rotates with the axis of the pump gear 36 in the counter-clockwise direction. As the wiper sled 26 is in the operational status of raising the wiper 24, thus the wiper sled 26 moves to a location where the bar 46 of the wiper 26 does not resist the rotation of the swing gear 40, therefore the swing arm 42 can rotates in the counter-clockwise direction to engage with the swing gear 40 and the rack 22 of the cap sled 20, as the swing gear 40 itself is already engaged with the pump gear 36, thus the pump gear is being driven to rotate in the clockwise direction, at this time the cap sled 20 is being driven in the −X direction as shown in FIG. 2 and FIG. 5, and the cap 18 moves upwards along the slanting track of the cap sled 20 such that the cap 18 rises to the position needed to cap the print head of the ink cartridge.

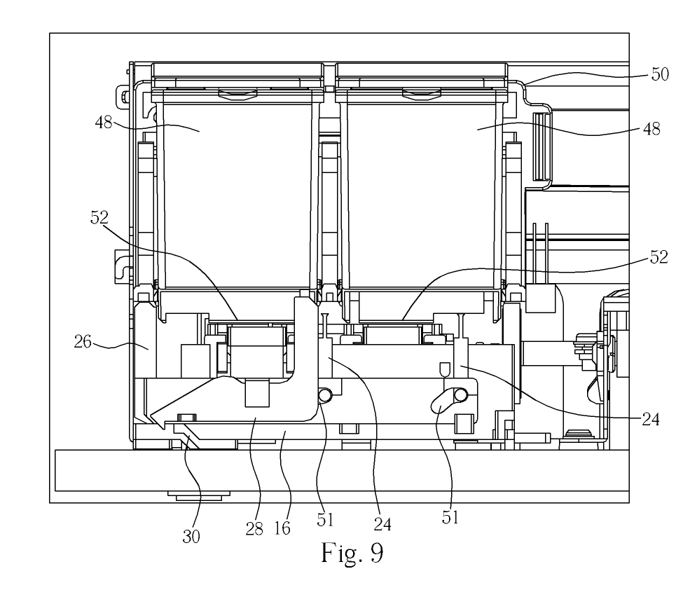

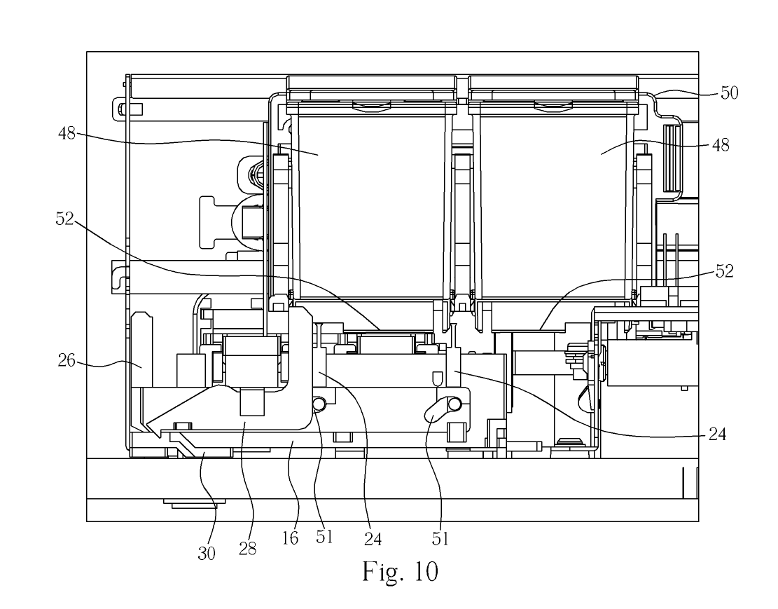

Please refer to FIG. 9 and FIG. 10. FIG. 9 and FIG. 10 illustrate a diagram of a carriage 50 carrying two ink cartridges 48 at different locations when a wiper sled 26 is in an operational status of raising the wiper 24. When the carriage 50 moves towards the left end to bring the two ink cartridges 48 back to the original location, the carriage 50 drives the wiper sled 26 to move towards the left, therefore the wiper 24 moves upwards on a track 51, and at this time the lock bar 28 connected to the wiper sled 26 is wedged within the stop component 30 of the base 16 to secure the wiper sled 26. As shown in FIG. 9 and FIG. 10, the wiper 24 is being driven upwards to a location higher than a print head 52 of the two ink cartridges 48, when the carriage 50 moves towards the right end from a location shown in FIG. 9 to a location shown in FIG. 10 to drive the two ink cartridges 48 towards the right, as interference is generated on the surface of the wiper 24 and the print head 52 of the ink cartridges 48, the wiper 24 can perform the action of removing ink residue. The lock bar 28 and the stop component 30 are interlocked to provide a lock force during the execution of removing ink residue, as the wiper sled 26 and the wiper 24 will not be driven due to the interference generated by the ink cartridge 48 and the wiper 24. After the ink residue is removed by the wiper 24, the carriage 50 continues to move to the right, at this time the carriage 50 pushes the top end of the lock bar 28 so that the lock bar 28 corresponding to the locked area with the stop component rotates, in doing so the bottom end of the lock bar 28 separates from the stop component 30, thus the wiper sled 26 can return to its original initialization status, which means that the wiper 24 will move down to a location lower than the print head 52 of the two ink cartridges 48. The wiper 24 of the present invention performs a method of up and down vertical movement. The present invention does not utilize the conventional method of the wiper 24 moving upwards in a diagonal manner to locate itself between the two ends of the carriage. As a result, the present invention is capable of reducing the width of the maintenance device.

In conclusion, when the printer is in the printing status, the wiper sled 26 and the cap sled 20 are in the initialization status, which means that the wiper 24 and the cap 18 are not yet raised; when the printer is in the capping and pumping status, the wiper sled 26 is being driven towards the left by the carriage 50, the wiper 24 will be driven upwards within the track 51, thus the wiper sled 26 is in the operational status of rising the wiper 24, in another words, the bar 46 installed on the wiper sled 26 will not resist the swing gear from rotating, at this time the feed gear 38 rotates in the clockwise direction, thus the swing gear 40 also rotates in the clockwise direction. The cap sled 20 is then being driven in the −X direction as shown in FIG. 2 by the swing gear 40, and the cap 18 moves upwards along the slanting track of the cap sled 20 to the location needed for capping the print head 52, thus the capping and pumping operation is executed on the print head 52; and when the printer is wiping the ink residue, as the lock bar 28 is wedged with the stop component 30 of the base 16, the wiper sled 26 is being locked in the operational status of raising the wiper 24, and the print head 52 of the ink cartridge 48 after wiping performs the printing operation, the feed gear 38 will rotate in the counter-clockwise direction, at this time the cap sled 20 is being driven in the +X direction as shown in FIG. 2 by the swing gear 40, and the cap 18 moves downwards along the slanting track of the cap sled 20, and the cap 18 will not be positioned in the location of capping the print head of the ink cartridge; after the wiper 24 execute the wiping operation on the print head 52, the carriage 50 continues to move right, at this time the carriage 50 pushes the top end of the lock bar 28 so that the lock bar 28 corresponding to the locked area with the stop component rotates, in doing so the bottom end of the lock bar 28 separates with the stop component 30, thus the wiper sled 26 and the cap sled 20 can return to their original initialization status. Furthermore, in the back and forth movement of the cap sled 20, as the cap sled 20 and the wiper 24 generate a relative motion, the sled 32 is capable of wiping the ink residue off the wiper 24.

In comparison to the conventional maintenance device, the maintenance device of the present invention requires the motor for feeding paper and the motor for moving the carriage for driving the ink cartridge to act as a driving force without requiring an external driving force, the present invention also solves the limitation of not being able to remove the ink residue during printing, and finally the present invention does not increase the width of the maintenance device such that the present invention achieves the four functions such as capping the print head, wiping ink residue from the print head, pumping ink from the print head of the ink cartridge, and scraping the ink residue off the wiper, in doing so, the cost of the maintenance device can be reduced and it is in step with the current trend of miniature design.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A maintenance device capable of cleaning a print head of an ink cartridge, the maintenance device comprising:
a maintenance module comprising:
a base;
a cap for capping a print head of an ink cartridge;
a cap sled installed on the base moving in a sliding manner for driving the cap upwards to cover the print head of the ink cartridge, an end of the cap sled having a rack; and
a pump module for pumping ink out of the print head of the ink cartridge, the pump module comprising:
a pump gear for engaging a feed gear;
a swing gear for engaging the pump gear; and
a swing arm coupled to the pump gear and the swing gear for driving the swing gear when being driven by the pump gear when the feed gear is driving the pump gear;
wherein the swing gear and the rack of the cap sled are installed at a location corresponding to where the swing gear engages the rack of the cap sled when the swing arm moves the swing gear to a predetermined position.

2. The maintenance device of claim 1 wherein the maintenance device further comprises:
a wiper;
a wiper sled for pushing a carriage of the ink cartridge being carried upwards to drive the wiper; and
a lock bar connected to the wiper sled for wedging within a stop component of the base to secure the wiper sled.

3. The maintenance device of claim 2 wherein the stop component is a convex block, an end of the lock bar is a hook structure for wedging the convex block.

4. The maintenance device of claim 2 wherein a bar is installed on the wiper sled for resisting the rotation of the swing gear.

5. The maintenance device of claim 2 further comprising a scraper, installed on the cap sled, for scraping ink residue on the wiper when the cap sled and the wiper generate a corresponding movement.

6. The maintenance device of claim 1 wherein the maintenance device further comprises a cap sled support for limiting the direction of the cap sled movement.
